(19) United States
(12) Patent Application Publication
(10) Pub. No.: US 2008/0176335 A1
(43) Pub. Date: Jul. 24, 2008

(54) APPARATUS AND METHOD FOR GENERATING NITROGEN OXIDES

(75) Inventors: David Marco Gertruda ALBERTI, Pijnacker (NL); Louis Marie SMEETS, Amsterdam (NL)

Correspondence Address: HAYNES AND BOONE, LLP, 901 Main Street, Suite 3100, Dallas, TX, 75202, US

(73) Assignee: THERMO FISHER SCIENTIFIC INC., WALTHAM, MA (US)

(21) Appl. No.: 11/967,625

(22) Filed: Dec. 31, 2007

(30) Foreign Application Priority Data
Dec. 29, 2006 (GB) 0626031.9

(51) Int. Cl. G01N 31/12

(52) U.S. Cl. 436/114; 422/94

(57) ABSTRACT

A combustion analyzer apparatus and method for combustion analysing a sample, the analyzer comprising a combustion chamber (82) for receiving a sample for combustion therein to form combustion products, and a fluid supply apparatus for supplying fluid(s) into the chamber. The fluid supply apparatus (130-140) comprises a nitrogen oxides (NOₓ) generating apparatus (140,190,210,240) and is arranged to supply NOₓ into the combustion chamber. A yield of sulphur dioxide in the combustion products may thereby be improved. The NOₓ generating apparatus may be operated at a raised working temperature. The NOₓ generating apparatus may be provided by an ozonator with a supply of nitrogen and oxygen. A Venturi tube arrangement (246) may draw the generated NOₓ into a (carrier or oxygen) gas line to the combustion chamber. Ozone may be supplied to the combustion products to convert nitrogen monoxide therein to nitrogen dioxide. The NOₓ and ozone may be supplied by a single device (210,240).

### CROSS REFERENCE

This application claims priority benefit of Great Britain Patent Application Number 0626031.9, filed Dec. 29, 2006.

Reference is made to co-pending application, entitled “Combustion analysis apparatus and method”, and filed on even date herewith, under attorney docket number 35365.12 (AJF/DP/P89536) and claiming priority from GB0626032.7, the entirety of which is incorporated herein by this reference.

### FIELD OF THE INVENTION

The invention relates to an apparatus and method for generating nitrogen oxides for use in the combustion analysis of samples comprising a proportion of sulphur.

### BACKGROUND OF THE INVENTION

Combustion analyzers are used to determine the concentration of one or more components of a sample, by combusting the sample and analysing the gaseous products for specific oxides. Typically, the carbon, sulphur and/or nitrogen content of the sample is measured by detecting CO₂, SO₂ and NO, respectively.

A schematic illustration of a typical combustion analyzer is shown in FIG. 1. The combustion analyzer 10 comprises a sample introduction stage 20, a combustion stage 30, a conditioning stage 40, and a detection stage 50. The sample introduction stage 20 comprises a sample introduction apparatus 22, to which are connected a supply of a sample 24, a supply of oxygen 26 and a supply of argon 27. The sample introduction apparatus 22 introduces these fluids into a combustion chamber 32 in a suitable form for combustion to take place. A further supply of oxygen 25 may be provided, directly into the combustion chamber 32. The combustion chamber 32 is heated by an electric heater 34, so that the sample is delivered into an oxygen-rich atmosphere at high temperature, typically of around 1000° C. The sample is thereby converted into various combustion products, such as CO₂, H₂O, SO₂, NO, etc. The combustion products leave the combustion chamber 32 and pass through the conditioning stage 40, where processes such as cooling, filtering, drying, etc. take place. The conditioned products then pass through one or more dedicated detectors 52, 54, in which properties of the components of the combustion products may be detected. For example, CO₂ may be detected by absorption of infrared radiation, using a non-dispersive infrared (NDIR) detector; SO₂ may be detected by fluorescence with ultraviolet light, using a light sensor; and NO can be detected from de-excitation processes following its reaction with ozone (O₃) to form excited NO₂, using a chemiluminescence light sensor. The detected signals are indicative of the respective amount of each component of the combustion products and can therefore be related to the composition of the original sample. Finally, the detected combustion products are passed out of the detection stage 50, as waste products 56.

The performance of such a combustion analyzer 10—in terms of its suitability, reliability, accuracy and robustness—depends strongly on its ability to convert the element(s) of interest in a sample into its/their respective oxide(s).

For combustion analysis of a sample containing sulphur, the combustion product to be detected is sulphur dioxide (SO₂). The achievable yield of SO₂ which may be detected with current combustion analyzers is around 90%. The yield is the proportion of the amount of sulphur originally contained in the sample which is actually converted to sulphur dioxide. The achievable yield of a combustion analyzer is calculated by analysing known, standard samples for calibration purposes. Once a calibration curve has been measured using standard samples, unknown samples may be analyzed and the detected values may be calibrated accordingly. However, samples and also combustion conditions in a combustion analyzer are subject to variation, with the result that the calibration curve cannot consistently provide accurate measurements from sample to sample.

Also, current compliance regulations for sulphur in petrochemical fuels mean that total sulphur specifications (i.e., the permissible amount of sulphur in any form) are at low parts per million (ppm) levels and are heading ever lower, towards sub-ppm levels. For example, diesel specifications for sulphur are soon expected to be 10 ppm in the EU and 15 ppm in the US; for gasoline (petrol), the specifications are expected to be 10 ppm in the EU and 80 ppm in the US. It is therefore increasingly important to be able to measure sulphur concentrations at such low levels.

Accordingly, it would be desirable to provide an improved apparatus and method for use in the combustion analysis of samples containing sulphur.

U.S. Pat. No. 4,879,246 relates to a device for the mineralization of carbonaceous material by heating a solid sample to 300-400° C. for 6-20 hours in a stream of oxygen and ozone/nitrogen oxides/chlorine. This is not a combustion analysis method and does not provide relevant teaching in combustion analysis.

GB 269,046 relates generally to an apparatus for ozonising air and converting it into nitric oxide and does not provide any teaching in combustion analysis.

### SUMMARY OF THE INVENTION

According to a first aspect of the invention, there is provided a combustion analyzer for combustion analysing a sample, the analyzer comprising: a combustion chamber for receiving a sample for combustion therein to form combustion products; and a fluid supply apparatus for supplying one or more fluids into the combustion chamber, wherein the fluid supply apparatus comprises a nitrogen oxides (NOₓ) generating apparatus and the fluid supply apparatus is arranged to supply NOₓ into the combustion chamber.

It has been found that nitrogen monoxide acts as a sulphur dioxide yield improver in the combustion analyzer. When added to the combustion analyzer, the nitrogen monoxide increases the yield of sulphur dioxide in the combustion products to be detected, relative to the yield of sulphur dioxide in the combustion products which would result when the substance is not added to the combustion analyzer. As such, with samples of low sulphur concentration, a greater quantity of sulphur dioxide, for a given sample volume or mass, can be produced, offering improved detection. Furthermore, depending on the amount of nitrogen monoxide used for a particular sample, it is possible to provide a consistently greater yield of sulphur dioxide from the sample than previously achievable. Thus, the effect of variations between samples and variations in other combustion conditions can be reduced, if not minimised. This can help to ensure that measurements made using the calibration curve are accurate from sample to sample.

NOₓ refers generally to oxides of nitrogen, which typically include nitrogen monoxide (NO), nitrogen dioxide (NO₂), dinitrogen trioxide (N₂O₃) etc., in various proportions. In operation, at temperatures generally reached in a combustion chamber (around 1000° C.), substantially all oxides of nitrogen are formed into nitrogen monoxide, so the NOₓ generated and supplied into the combustion analyzer serves as a source of nitrogen monoxide yield improver.

Preferably, the NOₓ is supplied to the combustion analyzer before and/or during combustion of the sample. This allows the NO to have effect while the combustion products are being formed, to help improve the yield from the outset of the combustion process. The mechanism by which the NO improves the yield of sulphur dioxide in the combustion gases may be such that the NO reduces sulphur trioxide to sulphur dioxide, or inhibits the formation of sulphur trioxide, or promotes the formation of sulphur dioxide, or a combination of these. Accordingly, it is preferred that the NOₓ be supplied before or during combustion of a sample, to allow the NO to have sufficient opportunity to have effect.

The NOₓ may be supplied to the combustion chamber of the combustion analyzer via a dedicated inlet. Thus, the NOₓ gases may be pumped directly into the combustion chamber. Again, such supply may take place before and/or during combustion.

Typically, combustion chambers have one or more inlet ports for receiving a supply of oxygen and a carrier gas, such as argon, respectively. For simple application of the invention to existing combustion analyzers, the NOₓ may be connected to the supply line for oxygen or a carrier gas, and carried into the combustion chamber therewith. The connection may be made anywhere along such supply line and is preferably in the form of a two-into-one connector (such as a ‘T’ piece).

Preferably, the connector or the apparatus connecting the NOₓ to a dedicated inlet, or to an oxygen supply line or a carrier gas supply line, is switchable between an on and an off state, so that during analysis of samples for which the NO yield improver is not required, the supply of the NOₓ may be stopped.

The provision of a NOₓ generator allows for a relatively simple technique for supplying a source of NO into the analyzer. A NOₓ generator may most simply be provided by modifying an ozonator to receive a supply of nitrogen and oxygen, instead of pure oxygen. With the use of a NOₓ generator, it is not necessary to spike or dilute a liquid sample with a nitrogen-containing compound, which process is labour intensive. The NOₓ produced may most straightforwardly be supplied into one or other of the gas supply lines. This allows for retrofitting of the NOₓ generator to existing combustion analyzers. It is also not necessary to provide a modified combustion chamber, in this case.

One particular advantage of the invention is that it is possible to use air (preferably first conditioned) as the supply of nitrogen and oxygen. Air intakes for ozonators typically condition the air by removing nitrogen, among other components. However, in embodiments of this invention, the nitrogen is not removed.

Preferably, the NOₓ generator is operated at a slightly elevated temperature, say between 10 and 30° C. above room temperature. This has been found to improve the yield of NOₓ from the generator.

Samples for combustion analysis may be petrochemicals, high-grade chemicals, or food and beverage specimens, for which the concentration of sulphur in the sample may be subject to regulation, so that at least an estimated, or expected, proportion of sulphur may be known before combustion analysis. If the proportion of sulphur is entirely unknown, a first quantity of the sample may be analyzed, to obtain an indication of the proportion of sulphur, so that an expected proportion of sulphur may be known for subsequent analyzes. Preferably, the amount of NOₓ supplied to the combustion analyzer is such that a proportion of NO yield improver in the combustion analyzer is greater than the expected proportion of sulphur in a sample. Advantageously, the proportion of NO yield improver to the expected proportion of sulphur is greater than 2 to 1. Preferably still, the proportion is greater than 4 to 1. It has been found that, with tests using standard samples, adding a greater proportion of NO yield improver than the expected (in the case of a standard sample, the known) proportion of sulphur increases the yield of sulphur dioxide. Above a ratio of NO yield improver to sulphur of about 4 or 5 to 1, it has been found that the yield of sulphur dioxide does not increase so rapidly but starts to level off. By relative proportions, or ratios, of NO to SO₂ is meant molar proportions/ratios, and not proportions/ratios based on volume or mass.

It is considered that, for most samples, a proportion of NO yield improver to the expected proportion of sulphur of up to 1000 to 1 would be sufficient to ensure that an increased and substantially consistent yield of sulphur dioxide is achieved, even taking into account potentially significant variations in the actual proportion of sulphur in different samples. In most cases, a proportion of NO yield improver to the expected proportion of sulphur of up to 25-50 to 1 would be more than sufficient. Indeed, a ratio of 5 to 1 may be preferable, for example, where large variations in the sulphur content are not expected between samples.

Since nitrogen monoxide, or a source thereof, is added to the analyzer, the combustion products at the detector may comprise nitrogen monoxide. The inventors have found that nitrogen monoxide interferes with the detection of sulphur dioxide, when using a UV fluorescence detector. It is therefore preferable to provide an ozone supply to the combustion products, prior to detection, where nitrogen monoxide would otherwise interfere. Ozone reacts with nitrogen monoxide to form nitrogen dioxide and oxygen, so may be used to remove the NO interference. The ozone is preferably added between the combusting step and the detecting step. The ozone may be added after the combustion chamber or to the detector, or to a location in between, such as the transfer tubing between the chamber and detector.

In this case, an ozone supply apparatus may be fitted to an existing combustion analyzer relatively straightforwardly, by adding a connection into the combustion products line between the combustion chamber and the detector. Preferably, the connector is a two-into-one connector, such as a ‘T’ piece or the like. Preferably, the ozone is supplied at a rate of between approximately 0.5 to 1 ml/s. Preferably also, the connector or the ozone supply apparatus is switchable between an on and an off state, so that ozone is not supplied when not required.

According to a further aspect of the invention, there is provided an apparatus for generating NOₓ and ozone, the apparatus comprising: an electric discharge generator having a discharge region and arranged to provide an electric discharge through the discharge region; a first, NOₓ conduit disposed in a first part of the discharge region and comprising a NOₓ source gas inlet for receiving a supply of NOₓ source gas into the NOₓ conduit and a NOₓ gas outlet for supplying NOₓ gas therefrom; a second, ozone conduit disposed in a second part of the discharge region and comprising an ozone source gas inlet for receiving a supply of ozone source gas into the ozone conduit and an ozone gas outlet for supplying ozone gas therefrom.

In this way, both NOₓ and ozone can be produced using the same electric discharge device. This can provide a saving on components, as only one power supply and transformer is required to provide the electric discharges.

Preferably, a Venturi tube with an oxygen flow therethrough is used to draw the generated NOₓ from the NOₓ generator into an inlet hole provided in the constriction of the Venturi tube.

According to a further aspect of the invention, there is provided a NOₓ generating apparatus comprising: an electric discharge generator having a discharge region and arranged to provide an electric discharge through the discharge region; a NOₓ conduit disposed in the discharge region and comprising a NOₓ source gas inlet for receiving a supply of NOₓ source gas into the NOₓ conduit and a NOₓ gas outlet for supplying NOₓ gas therefrom, wherein the NOₓ gas outlet comprises a Venturi tube having a tube constriction, an intake opening near the tube constriction, and a Venturi tube outlet downstream of the tube constriction, the Venturi tube being arranged to receive a fluid flow through the tube constriction such that NOₓ gas is drawn into the intake opening and supplied from the Venturi tube outlet.

According to a further aspect of the invention, there is provided a method of combustion analysing a sample in a combustion chamber of a combustion analyzer, the method comprising the steps of: supplying the sample to the combustion chamber; and combusting the sample to produce combustion products, characterised by the step of generating nitrogen oxides (NOₓ) and supplying the generated NOₓ to the combustion chamber.

According to a further aspect of the invention, there is provided a method of generating NOₓ and ozone, comprising the steps of: providing a single electric discharge region; passing a mixture of nitrogen and oxygen through a first part of the region, to generate NOₓ; and passing oxygen through a second part of the region, to generate ozone.

According to a still further aspect of the invention, there is provided the use of an ozonator with a nitrogen and oxygen supply to generate NOₓ for supply to a combustion chamber of a combustion analyzer.

The term combustion products is used here to mean any substances present in the combustion analyzer following the combusting step and this may include the sample, the yield improver, and other substances, such as oxygen or a carrier gas, and their respective constituents, both in pre-combustion and post-combustion forms.

Other preferred features and advantages of the invention are set out in the description and in the dependent claims which are appended hereto.

### BRIEF DESCRIPTION OF THE DRAWINGS

The invention may be put into practice in a number of ways and some embodiments will now be described, by way of non-limiting example only, with reference to the following figures, in which:

FIG. 1 shows a schematic layout of a typical, prior art combustion analyzer;

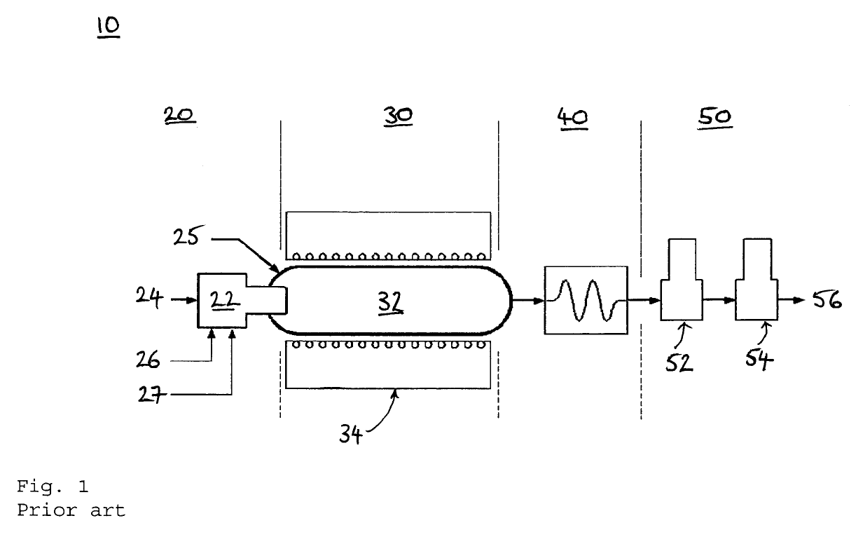

FIG. 2 shows a schematic layout of a combustion analyzer according to one embodiment of the invention;

FIG. 3 shows a schematic layout of a combustion analyzer according to another embodiment of the invention;

FIG. 4 shows a graph, illustrating the effects of adding a nitrogen compound into the combustion analyzer;

FIG. 5 shows a flow diagram illustrating the steps for generating NOₓ;

FIG. 6 shows a schematic cross section of a NOₓ generator according to one embodiment of the invention;

FIG. 7 shows a schematic cross section of a NOₓ and ozone generator according to another embodiment of the invention; and

FIG. 8 shows a schematic cross section of a NOₓ and ozone generator according to a further embodiment of the invention.

### DESCRIPTION OF PREFERRED EMBODIMENTS

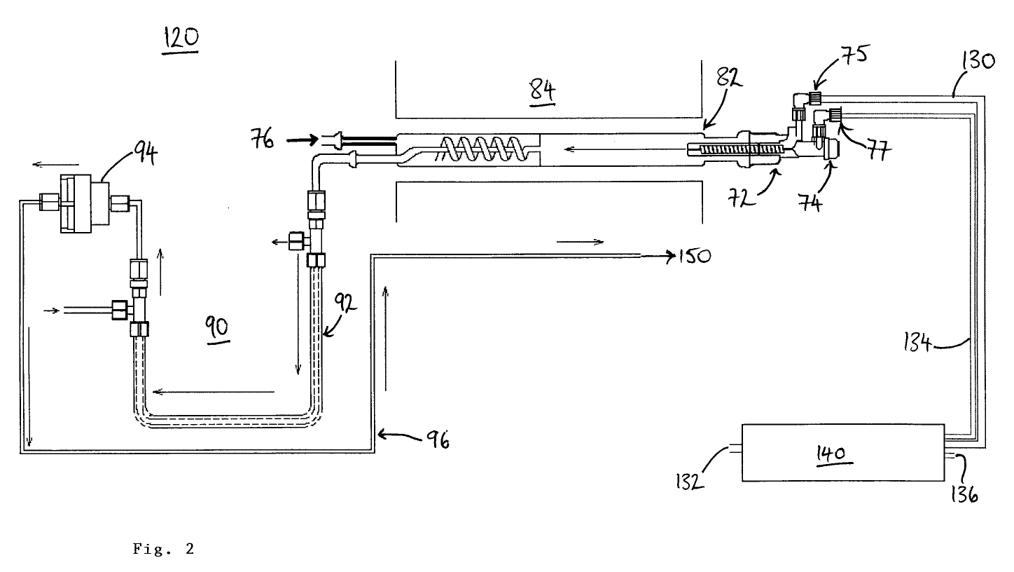

Referring to FIG. 2, there is shown a schematic layout of a combustion analyzer 120, in accordance with one embodiment of the invention. The combustion analyzer 120 has a sample introduction apparatus 72, which includes a sample supply inlet 74, an oxygen supply inlet 75, and a carrier gas supply inlet 77. The sample introduction apparatus 72 is connected to a combustion chamber 82, which is heated by a heater 84. The combustion chamber 82 is divided into two compartments, the second of which being a turbo compartment and having a further oxygen supply inlet 76, to promote complete combustion of a sample.

Combustion products formed in the combustion chamber 82 pass through a conditioning stage 90, before detection. In this example, the conditioning stage includes a dryer 92, which removes water from the combustion products, the water being entrained by a dry gas flow in the opposite direction to the combustion products, the dry gas flow flowing through an outer tube of the dryer. The conditioning stage also includes a filter 94.

The conditioned combustion products then pass through a combustion product line 96 to a detector 150.

The combustion analyzer 120 has an oxygen supply line 130 connected to the oxygen supply inlet 75. The oxygen supply line has an end 132 for connection to an oxygen feed unit (not shown). The combustion analyzer 120 has a carrier gas (typically argon) supply line 134 connected to the carrier gas supply inlet 77. The carrier gas supply line has an end 136 for connection to a carrier gas feed unit (not shown).

Installed on both the oxygen and the carrier gas supply lines 130, 134 is a NOₓ generator 140. The NOₓ generator 140 is configured to provide a supply of NOₓ into one, both or none of the oxygen and carrier gas supply lines 130, 134. The NOₓ generator 140 is connected to both supply lines 130, 134, by a switchable connector (not shown), which may be switched between various settings, depending on the application:

| Setting | Oxygen supply line | Carrier gas supply line |
|---|---|---|
| A | Oxygen | Carrier gas |
| B | Oxygen & NOₓ | Carrier gas |
| C | Oxygen | Carrier gas & NOₓ |
| D | Oxygen & NOₓ | Carrier gas & NOₓ |

In other embodiments, there may be more than one connector, which may or may not be switchable, between the NOₓ generator 140 and the oxygen supply line 130 and the carrier gas supply line 134. In still others, a connector may be fitted only to one of the supply lines 130, 134. Whichever way, in this embodiment, the NOₓ generator 140 is installed on, and therefore modifies, supply line tubing which is already on the outside of a combustion analyzer. In this way, the NOₓ generator 140 may be relatively straightforwardly retrofitted to existing combustion analyzers which are used to detect sulphur concentrations.

The NOₓ generator 140, in this embodiment, is configured to supply nitrogen oxide gases into one or both of the supply lines 130, 134. For a setting in which the NOₓ generator 140 is connected or switched into only the oxygen supply line 130, a flow of oxygen passes into end 132 and, from the supply line 130, into the supply inlet 75 and on into the combustion chamber 82. A typical flow rate for the oxygen is between 200 and 400 ml/min. The NOₓ gas is pumped into the oxygen supply line 130 through the connector, where it mixes with the oxygen, for supply to the combustion chamber. A preferred flow rate for the NOₓ gas is between 15 and 50 ml/min. Such a flow rate is generally suitable to provide an abundance of NO in the combustion chamber before and/or during the combustion process, so that the yield of SO₂ in the combustion products may be improved.

The combustion products formed in the combustion chamber 82—including an improved yield of SO₂—are carried through the conditioning stage 90 and along the combustion products line 96, by a general, background flow of carrier gas or oxygen through the analyzer 120. From the combustion products line 96, the combustion products are passed into one or more detectors 150 (not shown), one of which is configured to detect an amount of SO₂ therein.

The detector 150 for detecting SO₂ can be any suitable detector and is not limited to a UV fluorescence detector. For example, the detector 150 may be a coulometric detector using iodometric titration. In this case, the combustion gases containing SO₂ are passed through the electrolyte of a titration cell, containing tri-iodide (I₃⁻). The sulphur dioxide reacts with the tri-iodide to form a sulphate and iodide. This reaction changes the potential from its pre-set value of the cell and this is detected. At the anode, iodide is reduced to iodine, to compensate for the tri-iodide deficiency, by an applied current. The current is integrated over time, providing a measurement of the amount titrated sulphur dioxide, from which the amount of sulphur in the sample may be calculated. The reaction equations for this process are:

$$\begin{matrix}6 {H}_{2} 0 + {SO}_{2} + {I}_{3}^{-} & \to & {SO}_{4}^{2 -} + 3 {I}^{-} + 4 {H}_{3} {0}^{+} & \\ 2 {I}^{-} & \to & {I}_{2} + 2 {e}^{-} \} & at the anode \\ {I}_{2} + {I}^{-} & \to & {I}_{3}^{-} \} & at the anode \\ 2 {H}_{3} O + 2 {e}^{-} & \to & {H}_{2} + 2 {H}_{2} 0 \} & at the cathode\end{matrix}$$

Since the invention improves the detectable sulphur yield by increasing the yield of SO₂ in the combustion gases, the invention may be applied to any combustion analyzer employing a sulphur dioxide detection mechanism and provide corresponding advantages thereto.

Normally, when a sulphur-containing substance is combusted, approximately 90% of the sulphur is formed into sulphur dioxide and approximately 10% is formed into sulphur trioxide (SO₃). For this reason, most total sulphur detectors measure sulphur dioxide in one way or another. One common detector used is a UV fluorescence detector. Total sulphur ultraviolet (TSUV) detection is based on the principle that SO₂ molecules fluoresce; i.e., absorb UV light, become excited, then relax to a lower energy state, emitting UV light at a specific wavelength in the process. The emitted light is detected to provide a measure of the amount of SO₂ present.

However, the inventors have recognised that the readings taken by the above type of detector are not a result purely of SO₂ fluorescence. It has been found that the detector is unable to distinguish between SO₂ and NO, since they both fluoresce upon excitation with UV light in generally the same wavelength range. Accordingly, the inventors have appreciated that measurements made by such a detector may indicate higher levels of SO₂ than are actually present in the fluorescence chamber, since NO fluorescence can contribute to the detected signal. Many samples contain a proportion of nitrogen and so can be incorrectly quantified by the detector.

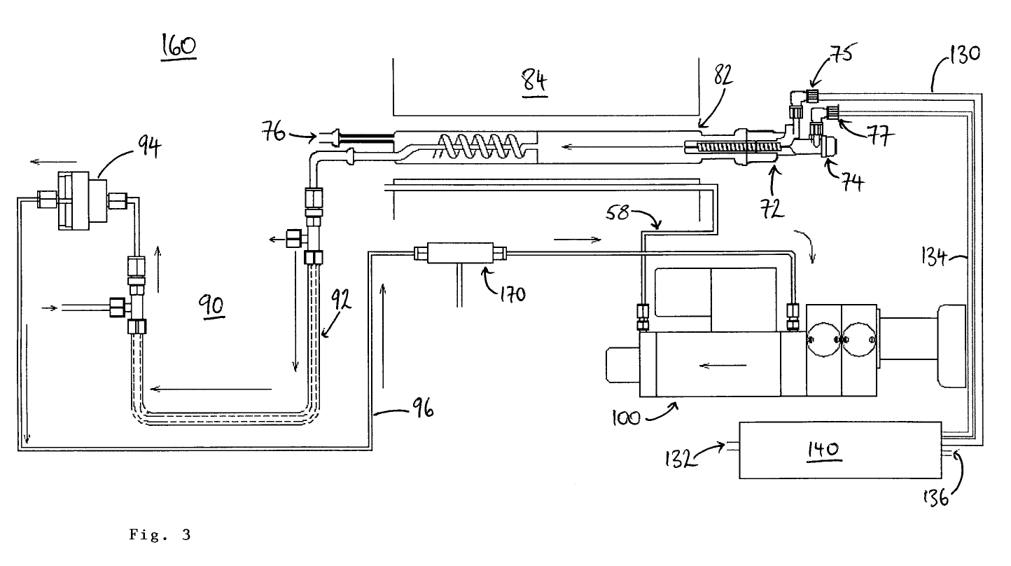

Accordingly, a method and apparatus for removing the interfering nitrogen monoxide from the combustion products is now discussed, in accordance with one embodiment of the invention and with reference to FIG. 3.

When it is desired to measure the concentration of nitrogen in a sample, it is known to use a total nitrogen (TN) detector, as mentioned above. This is a chemiluminescence detector, which measures the amount of light emitted when excited nitrogen dioxide falls to its ground state. The excited nitrogen dioxide is formed from the reaction of nitrogen monoxide with ozone (O₃). The reaction mechanism used in TN detectors has been applied in sulphur dioxide analysis.

FIG. 3 shows schematically a combustion analyzer 160, which is similar to that shown in FIG. 2, but with some modifications. At the end of the combustion products line 96, there is provided a UV fluorescence detector 100. An ozone generator 170 is installed on the combustion products line 96 between the combustion chamber 82 and the detector 100, so that any nitrogen monoxide in the combustion products may react with the ozone and thereby be removed from the combustion products and not be detected by the sulphur dioxide UV fluorescence detector 100. An ozonator (also known as an ozonizer) is preferably employed as the ozone generator 170.

The ozone generator 170 is configured to supply ozone to the combustion products line 96 at a rate sufficient to remove substantially all of the nitrogen monoxide. For example, an oxygen flow of 50 ml/min supplied to an ozonator has been found to be sufficient to remove the nitrogen monoxide formed from a nitrogen concentration in the combustion products of up to 9000 ppm.

The ozone mixed into the combustion products should preferably be supplied in a greater quantity than is needed to remove all NO gas, to help ensure substantially all NO gas is converted to NO₂. Since ozone is toxic, it should preferably not simply be pumped to waste. Accordingly, the combustion analyzer 160 has a waste discharge line 58, which passes through or near to the combustion chamber heater 84. In this way, ozone present in the waste products from the detector 100 may be thermally dissociated into oxygen before being discharged from the analyzer. Other techniques for ozone removal may alternatively be employed.

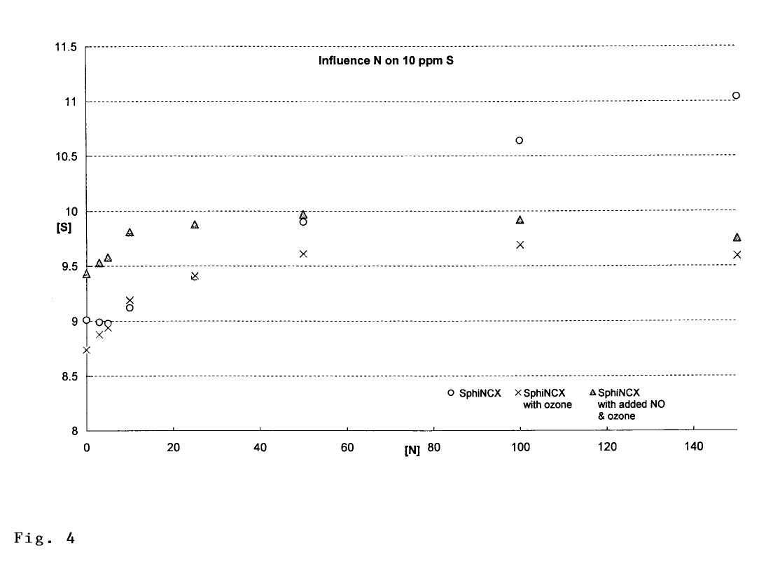

An experiment, using a combustion analyzer corresponding to the combustion analyzer 160, and its results will now be discussed. The experiment is discussed with reference to table 1, below, and FIG. 4. In the experiment, a set of known, standard samples was prepared, as follows. Eight different samples were prepared and each sample contained 10 ppm of a sulphur-containing substance. The samples also contained the following concentration of a nitrogen-containing substance, respectively: 0, 3, 5, 10, 25, 50, 100, and 150 ppm. The nitrogen-containing substance used was pyridine in xylene.

A combustion analyzer to detect SO₂ by UV fluorescence detection was modified to allow it to operate under a number of different conditions. The analyzer used was the SphiNCX analyzer, manufactured by Thermo Fisher Scientific Inc. The modifications made were to add a nitrogen oxides (NOₓ) generator to the oxygen supply line, by means of a switchable connector, and to add an ozone generator to the combustion products line, again by means of a switchable connector. The switchable connectors were used so that one or both of the supplies could be turned off, as required.

The following methods of analysis were used with each of the eight samples, respectively. For method A, the analysis was conducted with both the NOₓ and O₃ supplies turned off; that is, essentially, the SphiNCX analyzer was operating in its standard manner according to international standard ASTM D5453 for total sulphur determination. For method B, the analysis was conducted with the O₃ supply switched on and the NOₓ supply switched off. That is, the combustion process was as standard, but substantially all NO in the combustion products was removed. For method C, the analysis was conducted with both NOₓ and O₃ supplies turned on. That is, the analysis was as standard, but a yield improver gas was supplied to the combustion chamber, along with the oxygen supply, and substantially all NO in the combustion products was removed. When the ozone generator was employed, the ozone gas flow rate into the combustion products line was 50 ml/min. When the NOₓ generator was employed, the NOₓ flow rate into the oxygen supply line was between 34 and 40 ml/min. The sulphur-containing liquid used was thiophene.

The results of the tests are shown in table 1 and on the graph of FIG. 4. The results for method A generally show a rise in the detected concentration of total sulphur in the eight standard samples, with increasing nitrogen in the samples. With no added nitrogen-containing liquid in the sample (sample 1), the yield of SO₂ was around 90%. The apparent yield of SO₂ for sample 8 was around 110%, clearly confirming that the UV fluorescence detector was measuring a signal from an interfering substance (NO), in addition to the SO₂.

TABLE 1
Influence of added nitrogen with different methods
of determining sulphur on 10 ppm sulphur.

| | | Added N/ppm | | | | | | | |
|---|---|---|---|---|---|---|---|---|---|
| | | 0 | 3 | 5 | 10 | 25 | 50 | 100 | 150 |
| Detected | A | 9.01 | 8.99 | 8.98 | 9.12 | 9.40 | 9.90 | 10.64 | 11.04 |
| S/ppm by | B | 8.74 | 8.88 | 8.94 | 9.19 | 9.41 | 9.61 | 9.69 | 9.59 |
| method: | C | 9.43 | 9.53 | 9.58 | 9.81 | 9.88 | 9.97 | 9.92 | 9.75 |

The results for method B do not show an ever-increasing detected concentration of total sulphur, with increasing nitrogen concentration in the samples. Provided sufficient ozone is mixed with the combustion products, substantially all NO can be removed from them. This means that the signal generated by the detector is substantially wholly from the fluorescence of SO₂ and indicates that the actual yield of SO₂ was around 87%. Accordingly, a calibration curve based on standard samples analyzed using method B may be obtained and used to provide total sulphur measurements of unknown samples, without interference from NO in the detector.

However, the yield of SO₂ is not consistent across samples 1 to 8, but varies from around 87% to around 96%, as the nitrogen concentration in the samples varies. The yield does appear to level off at around 95-96% from nitrogen concentrations in the sample of about 40-50 ppm and, before that, there is a reasonable yield, of over 90%, for nitrogen concentrations above about 10 ppm.

Nevertheless, the yield of SO₂ is affected by variations in the concentration of nitrogen in the samples. Since, for actual samples, the concentration of nitrogen is unknown and may vary between samples, a calibration curve obtained under method B would be an improvement on one obtained under method A, but still could not assure consistent applicability.

The results for method C are similar to those for method B, in that the detected concentration of total sulphur does not continue increasing with increasing added nitrogen concentration in the sample, but also levels out. However, the yield is shifted upwards for all samples and the levelling off of the yield occurs at lower sample concentrations of nitrogen. Also, the variation in detected sulphur concentrations across samples 1 to 8 is much reduced, giving a higher, more consistent yield of SO₂. The increase in yield from method B to method C varies from around 2% to around 7%, perhaps averaging around a 4% increase. This confirms that the additional NO in the combustion chamber is acting to encourage the formation of SO₂. The levelling off of the detected sulphur concentration takes place, at around 98-99%, from added nitrogen concentrations in the sample from around 20-40 ppm. The yield is considered to be good for all of the samples tested using the supplied NOₓ gas, whether or not a nitrogen-containing liquid was also added to the sample. The yield range, from around 94% to around 99%, is more consistent than that, of around 87% to around 96%, for method B.

The fact that there is still some variation in the detected total sulphur concentration for the method C results may be due to a number of factors. General variations in the measurement conditions may have had an effect, as may variations in the conditions under which the eight samples were prepared. Also, this may be down to how readily the nitrogen monoxide was mixed with the sample during combustion. It may be that the nitrogen-containing liquid added to the sample itself enables the NO, once formed, to have its yield-improving effect on SO₂ formation from the early stages of combustion, since it is already mixed with the sample. However, the NOₓ gas, which is pumped in and forms NO in the combustion chamber, first needs to mix with the sample while combustion is taking place. This may explain why the yield of SO₂ is lower for lower concentrations of nitrogen-containing liquid in the sample, even though an additional supply of NO is provided to the combustion chamber as NOₓ gas, so that there is a relatively high overall concentration of NO in the chamber.

It is often generally known what the total sulphur concentration in a sample is, before measurement. For example, the sample may be taken from a high-grade chemical, or a food or beverage, or a petrochemical, each of which has a pre-defined, allowable total sulphur concentration. Even if the expected total sulphur concentration is in a working range between 0 and 100 ppm, the initial flow rate of NO gas can be set to correspond to a concentration of around 4-5 times the expected sulphur concentration and then reduced (or increased, if appropriate) for subsequent analyzes, once a first measurement of the total sulphur concentration has been made.

For example, once a combustion analyzer has been calibrated, any signal detected by a SO₂ UV fluorescence detector will look like fluorescence from SO₂, even if no sulphur-containing sample is being analyzed. NO gives a signal on total sulphur detectors, but at a signal level of about 1/100^{th} of that from sulphur dioxide (i.e., 100 ppm NO is ‘seen’ as about 1 ppm SO₂). Accordingly, if the working range of the analyzer is configured to detect total sulphur levels between 0 and 100 ppm, an initial flow rate for the NOₓ gas into the analyzer can be set so that the SO₂ detector measures a signal which looks like 4 ppm or more SO₂ (i.e., about 400 ppm of NO, which is around 4-5 times the expected total sulphur concentration). However, of course, the detected signal is not from SO₂, but from the deliberate NO interference passing into the detector. In practice, a pre-determined signal on the SO₂ detector will be known to represent a sufficient flow rate of NOₓ into the analyzer for any particular analysis regime. For example, the inventors have implemented the above embodiments by modifying a TS3000 combustion analyzer, manufactured by Thermo Fisher Scientific Inc. It has been found that an arbitrarily selected signal level of 300 mV on the SO₂ UV fluorescence detector indicates that there is a sufficient flow of NOₓ gas into the analyzer, to improve the SO₂ yield. Even with minor variations in the generation efficiency—so that, for example, the signal level may fluctuate by +/−20-40 mV, there is generally a sufficient quantity of NO in the combustion chamber to have the desired yield improving effect.

In some of the tests discussed above, an ozone feed unit was employed to remove any NO present in the combustion gases, before they were detected. Such a feed unit is not required when the detector 150, used to detect the SO₂ concentration, is not affected by NO interference. For example, it would not be required when a coulometric detector is used. Furthermore, it may be desirable not to mix ozone with the combustion products, even when a UV fluorescence detector is used. This may be so that evaluation or reference measurements may be made, or so that a total nitrogen chemiluminescence detector may be employed following the SO₂ detector.

Having said that, where a UV fluorescence detector 100 is used, it is preferable to add an ozone feed unit 170 onto the combustion products line 96, as shown in FIG. 3.

As described above, the yield improver may be provided by nitrogen monoxide gas or NOₓ gas. The gaseous yield improver may be pumped directly into the combustion chamber, via a dedicated inlet. Such inlet may be similar to that used for the additional oxygen supply 76, although the dedicated inlet for the yield improver may be located at any suitable position at either end of the combustion chamber 82. Alternatively, and more straightforwardly, the gaseous yield improver may be supplied into one of the oxygen or carrier gas supply lines 130, 134, as described above. The nitrogen monoxide is obtained from a NOₓ generator, configured to generate and then supply NOₓ into the combustion analyzer via any of the above routes, among others.

A NOₓ generator may be provided based on the principles of an ozonator. An ozonator (also known as an ozonizer) is an apparatus for the preparation of ozone by passing oxygen through an electrical discharge. The electrical discharge provides energy to break O₂ molecules, which are then able to re-form as O₃ molecules. The electrical discharge used is variously known as a silent discharge, a corona discharge, and a brush discharge, and is essentially a low-current electric discharge across a gas-filled gap, with a relatively high voltage gradient.

It has been found that passing nitrogen and oxygen through such an electrical discharge can produce sufficient quantities of NOₓ to be used as a source of nitrogen monoxide for the combustion analyzer. Advantageously, ambient air (preferably filtered and dried) can be used as the source of the nitrogen and oxygen into the ozonator.

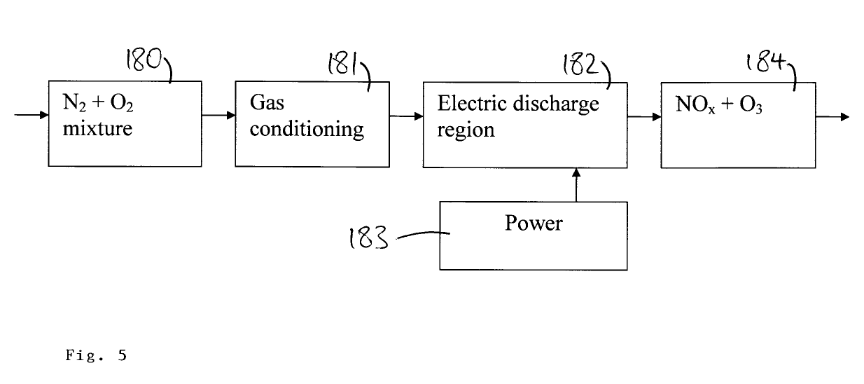

FIG. 5 shows a flow diagram of the steps which may be taken to generate NOₓ. In step 1 (180), a supply of nitrogen and oxygen is provided to the generator. In step 2 (181), depending on the source of the NOₓ source gases, they may need to be conditioned. For example, the gases may need to be dried, to remove any moisture, and filtered, to remove any particulate matter, such as dust. A suitable absorbent material for drying the NOₓ source gases is silica gel. A suitable filter is a PTFE particulate micro filter. Other types of conditioning may additionally or alternatively be used, as appropriate.

In step 3 (182,183), the (conditioned) gases enter an electric discharge region. The NOₓ generator includes a power and control unit, which applies an alternating voltage signal, through a transformer, to a first electrode. A second electrode, separated from the first electrode by a gap which provides the discharge region, may be connected to ground. Alternatively, a positive voltage peak my be applied to one electrode while a corresponding, negative voltage peak is applied to the other. In one embodiment, the power supply provides the transformer with approximately 55 Hz, 15 V pulses, which the transformer steps up to around 15 kV. Typically, however, the voltages applied to the electrodes are between 5 and 15 kV, with frequencies ranging from 50-60 Hz (mains supply), up to between 400 Hz and 1 kHz. The currently preferred supply values are a frequency of 200 Hz, with a half period in which +6 kV is applied to one electrode, then a half period in which −6 kV is applied to the other electrode. This results in a peak-to-peak voltage of 12 kV.

As the current discharges between the first electrode and the second electrode, some of the nitrogen and oxygen molecules are dissociated and ionised. Recombination of the excited species produces nitrogen oxides (NO, NO₂, N₂O₃ etc., or NOₓ) and ozone (O₃), as shown in step 4 (184), as well as oxygen. The generated NOₓ is then supplied to the combustion analyzer, where most of it will form NO at the temperature of the combustion chamber. Although such a NOₓ generator may not be highly consistent in its NOₓ generation efficiency, this is generally not a problem for the intended application, since the amount generated is considered to be sufficient to enable the desired sulphur dioxide yield improvement to be achieved.

As mentioned above, the NOₓ source gas may simply be air, which typically comprises around 80% of nitrogen and around 20% of oxygen. Alternatively, the gas may be a mixture of nitrogen and oxygen from gas bottles, preferably at a ratio of N₂ to O₂ of greater than 50:50. However, given the added cost and potential hazard of using gas bottles, and the simplicity of using air, the latter is preferred. The NOₓ source gas may be pumped into the NOₓ generator, or may be drawn into it, using the pressure drop of the combustion analyzer itself or of a dedicated suction device.

In applications where the NO yield improver is not required, the NOₓ generator may be switched off so that it becomes a passive part of the fluid supply apparatus of the combustion analyzer. In that way, any nitrogen and oxygen passing through the (de-activated) electric discharge region will remain unaffected and enter the combustion chamber unchanged. At typical temperatures of the combustion chamber, nitrogen remains stable and does not affect measurements of the combustion products. The oxygen will simply provide an additional amount of combustion gas in the chamber. Alternatively, the outlet to the NOₓ generator may be closed off by a valve, so that no gas passes into the combustion chamber from the NOₓ generator.

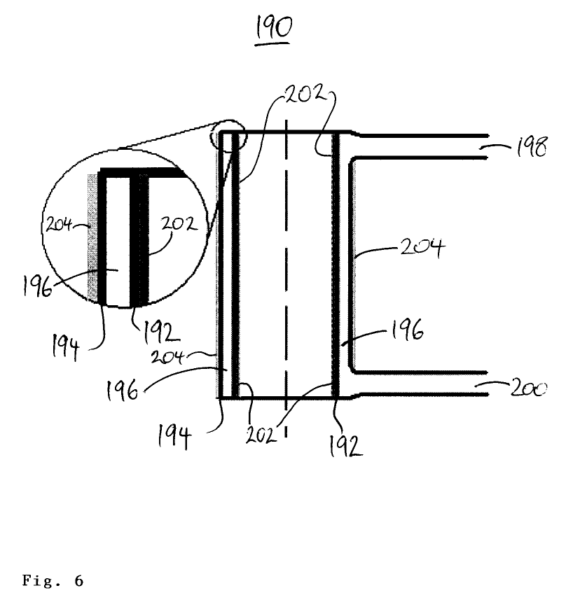

FIG. 6 shows a NOₓ generator 190 according to one embodiment of the invention. The NOₓ generator 190 is provided by a double-tube arrangement. That is, a first tube 192 is surrounded by a coaxial, second tube 194, the second tube having a larger diameter than that of the first tube. As such, an annular channel 196 is formed between the two tubes 192,194. An inlet pipe 198 is provided for supplying NOₓ source gas (nitrogen and oxygen) into the channel 196. An outlet pipe 200 is provided for receiving generated NOₓ gas from the channel 196. The inlet and outlet pipes 198,200 are at extremities of the NOₓ generator, to provide a large volume of the channel 196 over which NOₓ generation may take place. However, it is not important which way round the inlet and outlet pipes are configured. The NOₓ source gas enters the annular channel 196 from the inlet pipe 198 at one end, fills the channel around its circumference and along its length, is subjected to electric discharges, and leaves the channel out of the outlet pipe 200, comprising a proportion of NOₓ.

The tubes 192,194 and pipes 198,200 are preferably made from glass. The radial distance between an outer surface of the first tube 192 and an inner surface of the second tube 194 is between 0.5 and 5 mm, preferably between 1 and 2 mm. The currently preferred distance is 1.6 mm.

The double-tube arrangement is approximately 60 mm high and has a diameter of around 25 mm. The annular channel 196 between the tubes 192, 194 is enclosed at both ends, so that gas may enter and leave the annular channel only via the inlet and outlet pipes 198, 200.

The inside of the first tube 192 is hollow. Applied to the inner surface of the first tube 192 is a metallic film coating 202, preferably of silver. The coating 202 extends around the inner circumference and along the length of the tube 192 so as to provide a cylindrical, first electrode. Applied to the outer surface of the second tube 194 is a similar metallic film coating 204, providing a generally cylindrical, second electrode. In this way, the electrodes do not come into contact with the gases passing through the NOₓ generator. A portion of the NOₓ generator has been enlarged in a circle, for added clarity. A power and control unit (not shown) is connected to the first and second electrodes and is arranged to apply an appropriate voltage waveform thereto, in order to effect an electric discharge across the annular channel 196 between the electrodes.

The frequency of the applied waveform has a strong influence on the yield of generated NOₓ. The currently preferred waveform has +/−6 kV peaks and a frequency of 200 Hz. It is also possible to change the yield of generated NOₓ by controlling the gas flow speed through the NOₓ generator 190. The preferred flow rate of NOₓ source gas into the NOₓ generator 190 is around 40 ml/min. Other operational parameters and conditions are similar to those described with reference to FIG. 5, so no further discussion is given here.

One implementation of the above embodiment has been made, using a standard ozonator normally employed for the generation of ozone. The ozonator was modified to receive a supply of nitrogen and oxygen, instead of purely oxygen. Other operational configurations and conditions are as for the NOₓ generator of FIG. 6. The ozonator used was taken from the model 42C trace level NO—NO₂—NOₓ analyzer, manufactured by Thermo Fisher Scientific Inc.

With the above NOₓ generators, if it is desired to remove any NO present in the combustion gases, a further ozonator needs to be employed. In this case, the ozonator is configured as a standard ozonator; i.e. with a supply of (bottled) oxygen gas, at around 95% purity.

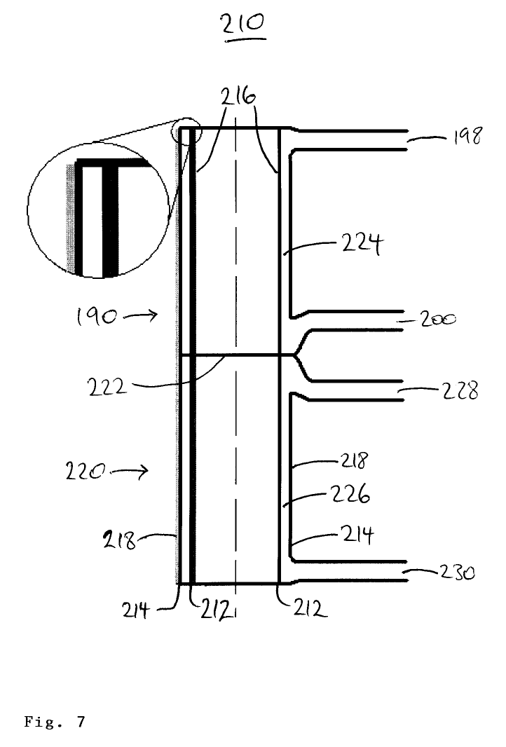

FIG. 7 shows a NOₓ generator 210 in accordance with a further embodiment of the invention, in which the generator is not only configured to generate NOₓ, but also to generate ozone. In this figure, similar or identical parts are labelled with the same reference numerals as those used in FIG. 6. In this combined generator 210, a NOₓ generator 190 is mounted axially adjacent an ozone generator 220. While in FIG. 7, the NOₓ generator 190 is shown as being disposed vertically above the ozone generator 220, it is not important which way round the generators are disposed.

The combined generator 210 has a first tube 212 surrounded by a coaxial, second tube 214, the first and second tubes being of similar dimensions to those stated above with reference to FIG. 6. However, the tubes 212, 214 are axially longer, at around 120 mm. A first electrode 216 extends around and along substantially the entire inner surface of the first tube 212. Similarly, a second electrode 218 extends around and along substantially the entire outer surface of the second tube 214.

However, an annular channel does not run along the entire length of the combined generator 210. A lateral partition 222, in the form of an annulus in this embodiment, is disposed midway along the combined generator 210, to separate the annular space between the two tubes 212, 214 into a first, NOₓ annular channel 224 and a second, ozone annular channel 226.

The NOₓ annular channel 224 has an inlet pipe 198 and an outlet pipe 200. The ozone annular channel 226 has an inlet pipe 228 for supplying oxygen into the channel. The channel 226 also has an outlet pipe 230 for receiving generated ozone gas from the channel. The NOₓ outlet pipe 200 is connected into a fluid supply apparatus for supplying the NOₓ to a combustion chamber of a combustion analyzer. The ozone outlet pipe 230 is configured to supply the ozone into the combustion products line connecting the combustion chamber to a detector.

A single power and control unit (not shown) is connected to the first and second electrodes 216, 218 and is arranged to apply an appropriate voltage waveform thereto, in order to effect an electric discharge across the annular channels 224, 226.

Thus, a distinct NOₓ generator and a distinct ozone generator are provided with a single, shared, first electrode 216 and a single, shared, second electrode 218 and a single, shared power and control unit. With this combined generator 210, it is possible to generate both NOₓ and ozone. A saving is therefore made, since it not necessary to employ two independent power and control units, which each include a transformer and a printed circuit board (PCB). Instead, a single power and control unit is able to operate the combined generator 210.

It has been found that the combined generator 210 is able to function effectively—i.e. produce sufficient yields of NOₓ and ozone—even if the power and control unit is configured to operate in exactly the same manner as it is for a single ozonator. It may be that the efficiency of NOₓ and ozone production is not as high compared with a single NOₓ generator or a single ozone generator operated by such a power and control unit. However, it is considered to be more than adequate for the purposes of NOₓ generation to provide NO yield improver and ozone generation to remove unwanted downstream NO interferences. If it were desired to maintain the same efficiency of NOₓ generation and of ozone generation as compared with their entirely separate generation, the combined generator 210 would require more power.

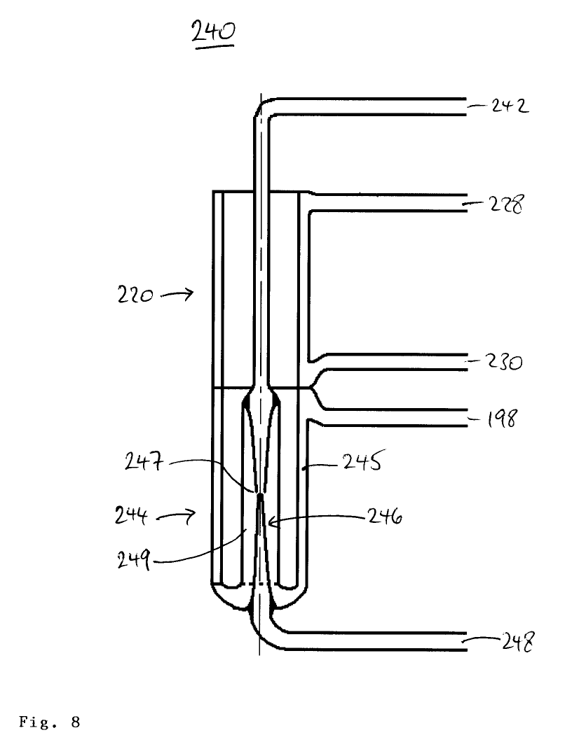

FIG. 8 shows a combined generator 240 in accordance with a further embodiment of the invention. The combined generator 240 is similar to that of FIG. 7, apart from a modification which has been made to the NOₓ outlet pipe 242. In this embodiment, the NOₓ generator 244 has a Venturi tube 246 running through the hollow centre of the generator. The Venturi tube 246 has an opening 247 at its constriction. The Venturi tube 246 is connected to a supply of oxygen 248 at an upstream end and to the NOₓ outlet pipe 242 at a downstream end. The NOₓ outlet pipe 242 runs through the hollow centre of the ozone generator 220 and out of the combined generator 240. The NOₓ annular channel 245 is connected at one end to the NOₓ source gas inlet pipe 198. At the other end, the annular channel 245 leads into a chamber 249 which surrounds the Venturi tube 246. NOₓ gas generated by electric discharges across the annular channel 245 is drawn through the chamber 249 and into the Venturi tube 246 via the opening 247, as a result of the pressure drop at the constriction as the oxygen gas flows therethrough. Thus a mixture of NOₓ gas and oxygen leaves the Venturi tube 246 and is supplied from the NOₓ outlet pipe 242 into a combustion chamber. The Venturi tube is preferably configured to provide a pressure drop of 1.2 kPa (9 mmHg) and thereby to draw the NOₓ gas through the opening 247 at a rate of between 30 and 40 ml/min. This is advantageous in that it is not necessary to provide an additional pump for the NOₓ gas flow.

In a preferred arrangement of the above embodiment, the oxygen supply 248 is that which feeds into a combustion chamber as the standard combustion gas supply line. In that way, the oxygen supply line is simply opened up and diverted through the combined generator 240 on its way to the combustion analyzer. This means that a separate inlet port for the NOₓ gas into the combustion chamber is not necessary, since the NOₓ is supplied into the chamber with the usual oxygen supply.

The NOₓ generator, or the combined ozone and NOₓ generator, may be operated at room temperature. However, it has been found that increasing the temperature of the generator by around 10° C. above room temperature results in a corresponding increase in the yield of NOₓ from the generator. Similar benefits are expected from a working temperature for the generator of up to 40-50° C. This is probably down to an increase in the reaction speed for NOₓ generation and/or the removal of moisture from the system due to the higher temperatures. It has been found that moisture in the outlet of the NOₓ generator can effectively reduce the NOₓ levels almost down to base levels, probably by reacting with the NOₓ to form nitric acid.

Preferably, heat evolved from other parts of the combustion analyzer is transferred to the generator in order to heat it. For example, the heat may be that from an ozone killer unit.

Various modifications of the above NOₓ generators and combined NOₓ and ozone generators are envisaged and provide further embodiments of the invention. For example, the Venturi tube arrangement is described above with reference to a combined generator, but may alternatively be used with a single NOₓ generator to similar effect.

It has been shown that NO, formed from NOₓ pumped into the combustion analyzer, increases the yield of SO₂ in the combustion products. It has also been shown that, by mixing ozone with the combustion products prior to detection, it is possible to remove substantially all NO (whether from the sample or added NOₓ gas) from the combustion products. According to embodiments of the invention, then, it is possible to increase the SO₂ yield and to improve the accuracy of the SO₂ detection.

Since variations in the amount of nitrogen monoxide in the analyzer affect the yield of SO₂, it is preferable to supply NOₓ to the analyzer in sufficient quantities that any variations in the composition of the (unknown) samples have a negligible effect on the yield of SO₂, since the influence of the supplied NO on the yield will be much more significant.

As stated above, total sulphur combustion analyzers cannot make absolute measurements because the sulphur in a sample is not completely converted into SO₂. A calibration curve is therefore necessary and it is important that the known, standard samples used to obtain the calibration curve are analyzed under the same conditions as unknown samples, otherwise the results will not be accurate. By providing an excess concentration of NO in the analyzer, preferably around 4-5 times the expected concentration of sulphur in the sample, not only a substantially consistent yield, but also an increased yield, of SO₂ may be achieved. This principle applies to all total sulphur combustion analyzers.

As already described with some of the embodiments above, more than one technique for supplying the yield improver to the combustion analyzer may be used together, if desired. For example, liquid yield improver (such as pyridine, benzonitrile and 2-ethylhexyl nitrate) may be added to the sample before detection and gaseous yield improver may be supplied to the combustion chamber before and/or during combustion.

As shown empirically in the above experiment, a sulphur dioxide yield improvement is achieved when the proportion of yield improver is greater than an expected proportion of sulphur in the combustion analyzer. FIG. 4 shows that a relative proportion of yield improver to expected sulphur of 2 to 1 or above provides a significant yield improvement. Between 4 and 5 to 1, the yield of sulphur dioxide does not increase so rapidly, but starts to level off. Nonetheless, for certain types of sample or entirely unknown samples, it may be preferable to supply yield improver to the combustion analyzer with a ratio of yield improver to expected sulphur proportions of up to 25-50 to 1, or even 100 to 1. For example, with a low-range detector, detecting around 0 to 100 ppm sulphur, an abundance of yield improver may be considered to be present in the combustion analyzer, when there is around 1000 ppm of the yield improver.

Preferably, the yield improver is supplied before or during combustion. It is most logical to supply the yield improver into the combustion chamber 82, either directly or indirectly.

Where ozone is added to the combustion analyzer, the preferred flow rate for the oxygen into the ozone generator is set by a flow controller to be 50 ml/min. However, the ozone flow rate may be between approximately 0.5 and 1 ml/s, or any other suitable flow rate for removing interfering nitrogen monoxide from the combustion products.

The invention may be applied to all combustion analysis instruments, which detect total sulphur by measuring sulphur dioxide levels. This applies to dedicated total sulphur instruments, which are configured only to measure total sulphur. This also applies to multi-use instruments, which are configured to detect total sulphur as well as other components of a sample. For example, total sulphur and total nitrogen instruments are known and this invention may be applied to them.

A TS+TN instrument may be configured firstly to combust a first sample, secondly to measure the total sulphur in that first sample, and thirdly to measure the total nitrogen in that first sample. Alternatively, the instrument may be configured to combust a first sample and detect the total sulphur in that first sample, then to combust a second sample and to detect the total nitrogen in that second sample, where the first and second samples are of identical composition.

Where the same combustion sample is detected by both detectors, the total sulphur must be measured before the total nitrogen. This is because sulphur dioxide is adsorbed by the material, stainless steel, used in the detector tubing and chamber for a total nitrogen detector. Accordingly, if the total nitrogen were measured first, the subsequent total sulphur measurement would be compromised. As such, where total sulphur is measured, with added nitrogen monoxide to improve the yield and added ozone to remove the nitrogen monoxide, a total nitrogen measurement is not then possible, since substantially all of the nitrogen monoxide in the combustion products is removed by the ozone. The combustion analyzer is therefore preferably switchable, so that the addition of a yield improver and/or supply of ozone may be turned on and off, as desired. A first sample can be analyzed with the option on, so improving the detection of sulphur dioxide; and a second, identical sample can be analyzed with the option turned off, so that total nitrogen may be measured. For the second sample, the total sulphur could also be measured at the same time, but this measurement would suffer from the possible problems of inconsistent sulphur dioxide yield and nitrogen monoxide interference.

In view of the fact that total sulphur detection must take place before total nitrogen detection in a combined combustion analyzer, the introduction of an ozone feed unit to the combustion products line leading to the SO₂ detector and the addition of ozone to the combustion products before detection by the SO₂ detector are considered to be new and advantageous aspects of the invention.

The invention may be employed for various applications in, for example, the chemical, refinery, hydrocarbon, petrochemical, and food and beverage sectors. The invention may be used in the analysis of solid, high-viscosity, liquid or gaseous samples. In particular, the invention may be used in the analysis of refinery products, such as gasoline and diesels.

1. A combustion analyzer for combustion analysing a sample, the analyzer comprising:
a combustion chamber for receiving a sample for combustion therein to form combustion products; and
a fluid supply apparatus for supplying one or more fluids into the combustion chamber,
wherein the fluid supply apparatus comprises a nitrogen oxides (NOₓ) generating apparatus and the fluid supply apparatus is arranged to supply NOₓ into the combustion chamber.

2. The analyzer of claim 1, wherein the NOₓ generating apparatus comprises an electric discharge generator having a discharge region, the electric discharge generator being arranged to receive a supply of nitrogen and a supply of oxygen in the discharge region and to provide an electric discharge through the discharge region such that NOₓ is generated.

3. The analyzer of claim 2, wherein the supply of nitrogen and the supply of oxygen are provided by air.

4. The analyzer of claim 1, wherein the NOₓ generating apparatus is switchable between a first on state in which NOₓ may be generated and supplied to the combustion chamber and a first off state in which NOₓ may not be generated.

5. The analyzer of claim 1, the fluid supply apparatus further comprising a NOₓ supply line for receiving generated NOₓ from the NOₓ generating apparatus, wherein the NOₓ supply line has a connection into the combustion chamber.

6. The analyzer of claim 1, the fluid supply apparatus further comprising a NOₓ supply line for receiving generated NOₓ from the NOₓ generating apparatus and an oxygen supply line and/or a carrier gas supply line which feeds into the combustion chamber, wherein the NOₓ supply line has a respective connection into one or both of the oxygen supply line and the carrier gas supply line.

7. The analyzer of claim 1, further comprising:
a combustion products line connected to the combustion chamber for transferring combustion products therefrom to a downstream detector; and
an ozone supply apparatus having a connection into the combustion products line for supplying ozone thereto.

8. The analyzer of claim 1, wherein the NOₓ generating apparatus comprises a heating apparatus arranged to raise a working temperature of the NOₓ generating apparatus.

9. The analyzer of claim 8, wherein the heating apparatus is arranged, in use, to transfer heat from an ozone killer unit to the NOₓ generating apparatus.

10. The analyzer of claim 1, wherein the NOₓ generating apparatus is provided by an ozonator arranged to receive a supply of nitrogen and a supply of oxygen to generate NOₓ therefrom.

11. The analyzer of claim 7, wherein the NOₓ generating apparatus and the ozone supply apparatus are provided together by:
an electric discharge generator having a discharge region and arranged to provide an electric discharge through the discharge region;
a first, NOₓ conduit disposed in a first part of the discharge region and comprising a NOₓ source gas inlet for receiving a supply of NOₓ source gas into the NOₓ conduit and a NOₓ gas outlet for supplying NOₓ gas therefrom;
a second, ozone conduit disposed in a second part of the discharge region and comprising an ozone source gas inlet for receiving a supply of ozone source gas into the ozone conduit and an ozone gas outlet for supplying ozone gas therefrom.

12. The analyzer of claim 11, wherein the first conduit is disposed adjacent to the second conduit and separated therefrom by a partition.

13. The analyzer of claim 11, wherein the electric discharge generator comprises a single power and control unit.

14. The analyzer of claim 11, wherein the NOₓ gas outlet comprises a Venturi tube having a tube constriction, an intake opening near the tube constriction, and a Venturi tube outlet downstream of the tube constriction, the Venturi tube being arranged to receive a fluid flow through the tube constriction such that NOₓ gas is drawn into the intake opening and supplied from the Venturi tube outlet.

15. The analyzer of claim 1, wherein the NOₓ generating apparatus comprises:
an electric discharge generator having a discharge region and arranged to provide an electric discharge through the discharge region;
a NOₓ conduit disposed in the discharge region and comprising a NOₓ source gas inlet for receiving a supply of NOₓ source gas into the NOₓ conduit and a NOₓ gas outlet for supplying NOₓ gas therefrom,
wherein the NOₓ gas outlet comprises a Venturi tube having a tube constriction, an intake opening near the tube constriction, and a Venturi tube outlet downstream of the tube constriction, the Venturi tube being arranged to receive a fluid flow through the tube constriction such that NOₓ gas is drawn into the intake opening and supplied from the Venturi tube outlet.

16. The analyzer of claim 15, wherein the fluid is oxygen and the Venturi tube outlet is configured to supply a mixture of oxygen and NOₓ therefrom.

17. A method of combustion analysing a sample in a combustion chamber of a combustion analyzer, the method comprising the steps of:
supplying the sample to the combustion chamber; and
combusting the sample to produce combustion products,
characterised by the step of generating nitrogen oxides (NOₓ) and supplying the generated NOₓ to the combustion chamber.

18. The method of claim 17, wherein the NOₓ is supplied to the combustion chamber before and/or during combustion.

19. The method of claim 17, wherein the NOₓ is generated by passing an electric discharge through a mixture of nitrogen and oxygen.

20. The method of claim 19, wherein the mixture is air.

21. The method of claim 17, further comprising the step of supplying ozone to the combustion products to convert at least a proportion of any nitrogen monoxide in the combustion products to nitrogen dioxide.

22. The method of claim 17, wherein the NOₓ is generated by an ozonator receiving a supply of nitrogen and a supply of oxygen.

23. The method of claim 17, wherein the NOₓ is generated at a temperature of between 30 and 50° C.

24. The method of claim 21, wherein the NOₓ and ozone are generated by:
providing a single electric discharge region;
passing a mixture of nitrogen and oxygen through a first part of the region, to generate NOₓ; and
passing oxygen through a second part of the region, to generate ozone.

25. The use of an ozonator with a nitrogen and oxygen supply to generate nitrogen oxides (NOₓ) to be supplied to a combustion chamber of a combustion analyzer.
